(19) United States
(12) Patent Application Publication
(10) Pub. No.: US 2020/0097870 A1
(43) Pub. Date: Mar. 26, 2020

(54) WORK TASK COMMITMENT MANAGER

(71) Applicant: salesforce.com, inc., San Francisco, CA (US)

(72) Inventors: Michael Patrick MCGINTY, Alameda, CA (US); Nicholas MCDUFFIE, Dublin, CA (US)

(21) Appl. No.: 16/351,138

(22) Filed: Mar. 12, 2019

Related U.S. Application Data
(60) Provisional application No. 62/735,275, filed on Sep. 24, 2018.

(51) Int. Cl. G06Q 10/06; G06F 17/18

(52) U.S. Cl. CPC G06Q 10/0639; G06Q 10/063118; G06F 17/18; G06Q 10/063114

(57) ABSTRACT

A method and system of managing work task commitments for a software development sprint has been developed. First, a plurality of work task commitments are assigned to individual development team members. Performance metrics and progress in the completion of the plurality of work task commitments are tracked and displayed. The performance metrics for each work task commitment are stored and any uncompleted work task commitment is rolled forward to a subsequent sprint along with its performance metrics.

### CROSS-REFERENCE TO RELATED APPLICATION(S)

This application claims the benefit of U.S. provisional patent application Ser. No. 62/735,275 filed on Sep. 24, 2018 entitled “Work Task Commitment Manager”.

### TECHNICAL FIELD

Embodiments of the subject matter described herein relate generally to software product development. More particularly, embodiments of the subject matter relate to a work task commitment manager.

### BACKGROUND

Project management of product development is typically complex. This is especially true for large teams of individuals are involved in developing technical products such as computer software. Managing individual tasks to completion of the overall project requires constant monitoring of the status of multiple individuals along with multiple assigned tasks. Hence, there is a need for a work task commitment manager.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 shows a display of a task commitment confirmation for a sprint session in accordance with one embodiment;

FIG. 2 shows mobile device displays for a sprint task commitment monitoring tool in accordance with one embodiment; and

FIG. 3 shows a display of a dashboard for monitoring commitment status and statistics for a sprint session in accordance with one embodiment.

FIG. 4 shows a flow chart of a method for task commitment confirmation for a sprint session in accordance with one embodiment; and

FIG. 5 shows a schematic block diagram of an exemplary multi-tenant computing environment in accordance with one embodiment.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All the embodiments described herein are exemplary embodiments provided to enable persons skilled in the art to make or use the invention and not to limit the scope of the invention which is defined by the claims.

A method and system for managing work task commitments for software development sprint has been developed. First, a plurality of work task commitments are assigned to individual development team members. The performance metrics and progress and completion of the work task commitments are tracked and displayed. The performance metrics are stored for each work task commitment during the sprint. Any uncompleted work task commitments are rolled forward to subsequent sprint along with the performance metrics of the uncompleted work task commitment.

A “scrum” is a framework for managing knowledge work, such as software development. It is typically designed for teams of three to nine members, who break their work into actions that can be completed within timeboxed iterations, called “sprints”, no longer than one month and most commonly two weeks, then track progress and re-plan in short (e.g., 15 minute) stand-up meetings, called daily scrums. Approaches to coordinating the work of multiple scrum teams in larger organizations include Large-scale Scrum (LeSS), Scaled agile framework (SAFe), scrum of scrums, and Scrum@Scale, among others.

In software product development, a sprint is defined as a set period of time during which specific work must be completed and made ready for review. The Sprint functions as the basic unit of development in a scrum. Each sprint begins with a planning meeting. During the meeting, the product owner (the person requesting the work) and the development team agree upon exactly what work will be accomplished during the sprint. The development team has the final say when it comes to determining how much work can realistically be accomplished during the sprint with each team member agreeing to accomplish specific work tasks or “commitments”. In alternative embodiments, the term “forecast” could be used in place of commitment to describe specific work tasks. The duration of a sprint is determined by, the team's facilitator or “scrum master”.

The sprint is a timeboxed effort that is restricted to a specific duration. The duration is fixed in advance for each sprint and is normally between one week and one month, with two weeks being the most common. Each sprint starts with a sprint planning event that aims to define a sprint backlog, identify the work for the sprint, and make an estimated forecast for the sprint goal. Each sprint ends with a sprint review and sprint retrospective, that reviews progress to show to stakeholders and identify lessons and improvements for the next sprints. A scrum emphasizes a working product at the end of the sprint that is really done. In the case of software, this likely includes that the software has been fully integrated, tested and documented, and is potentially shippable.

At the beginning of a sprint, the scrum team holds a sprint planning event to: discuss and agree on the scope of work that is intended to be done during that sprint; select product backlog items that can be completed in one sprint; and prepare a sprint backlog that includes the work needed to complete the selected product backlog items. As the detailed work is elaborated, some product backlog items may be split or put back into the product backlog if the team no longer believes they can complete the required work in a single sprint.

Each day during a sprint, the team holds a daily scrum (or stand-up) with specific guidelines. Specifically, the daily scrum should: start precisely on time even if some development team members are missing; happen at the same time every day; and be limited (timeboxed) to fifteen minutes. During the daily scrum, each team member provides three updates: what did I complete yesterday; what do I plan to complete today; and do I see any impediment that could prevent meeting our sprint goal. Any impediment (e.g., stumbling block, risk, issue, delayed dependency, assumption proved unfounded) identified in the daily scrum should be captured by the scrum master and displayed on the team's scrum board or on a shared risk board, with an agreed person designated to working toward a resolution (outside of the daily scrum).

At the end of a sprint, the development team holds two events: the sprint review and the sprint retrospective. At the sprint review, the team will: review the work that was completed and the planned work that was not completed; present the completed work to the stakeholders (e.g., a demonstration); and collaborate with the stakeholders on what to work on next. At the sprint retrospective, the team will: reflect on the past sprint; and identify and agree on improvement actions going forward. These events are facilitated by the scrum master.

Although not typically considered as a core part of scrum, a backlog refinement may be done. The “backlog refinement” (sometimes called backlog grooming) is the ongoing process of reviewing product backlog items and checking that they are appropriately prioritized and prepared in a way that makes it clear and executable for teams. Product backlog items may be broken into multiple smaller tasks, acceptance criteria may be clarified, and dependencies, investigation, and preparatory work may be identified. The backlog refinement may also include “technical debt” (also known as design debt or code debt). This is a concept in software development that reflects the implied cost of additional rework caused by choosing an easy solution now instead of using a better approach that would take longer.

The product owner can cancel a sprint if necessary. The product owner may do so with input from the team, scrum master or management. For instance, management may wish the product owner to cancel a sprint if external circumstances negate the value of the sprint goal. If a sprint is abnormally terminated, the next step is to conduct a new sprint planning, where the reason for the termination is reviewed.

Once the team reaches a consensus for how many days a sprint should last (called a “time box”), all future sprints should be the same. Typically, a sprint lasts 30 days. During the sprint, the team holds daily stand up meeting to discuss progress on completing commitments and brainstorm solutions to problems. Only the scrum master or project manager has the power to interrupt or stop the sprint. At the end of the sprint, the team presents its completed work to the project owner and the project owner uses the criteria established at the sprint planning meeting to either accept or reject the work.

Consequently, a work task commitment manager for use with a sprint has been developed. Once work begins on the sprint, embodiments of the work task commitment manager will store the commitments by individual members of the team. It will also provide statistical analysis to gain insights into the workflow during the sprint. Additionally, commitments that are not met during the sprint may be rolled over to a subsequent sprint. Some embodiments may store the past history of the commitment and move it to a subsequent sprint. This allows for “story pointing” that contains details of the work, original time estimates for the commitment and details of the delays and problems encountered. In this manner, a more complete picture of the work accomplished is available to subsequent sprints.

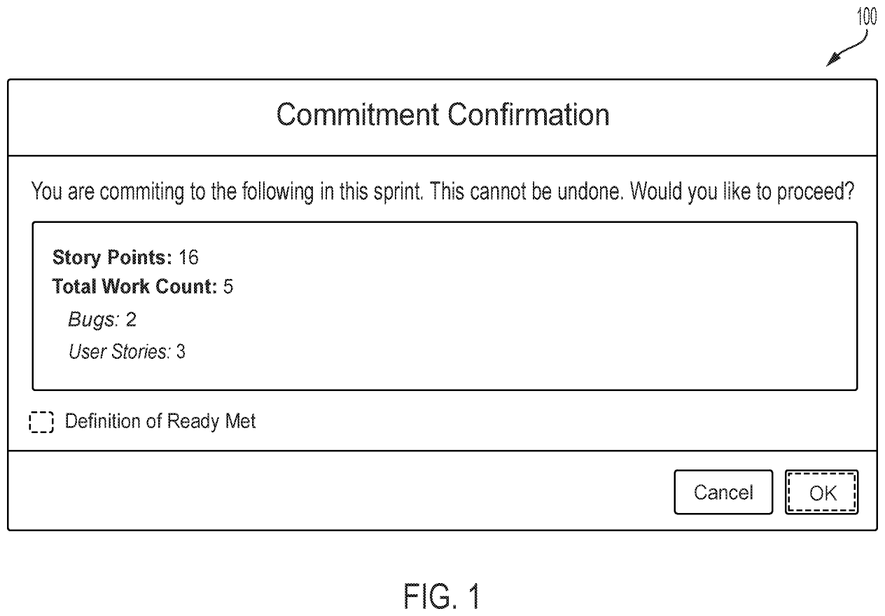

Turning now to FIG. 1, a display 100 is shown of a task commitment confirmation for a sprint session in accordance with one embodiment. The commitment confirmation is presented to an individual development team member. It summarizes the number and categories of task that are assigned. Also, the display allows the team member to lock in their individual sprint commitments after completing sprint planning.

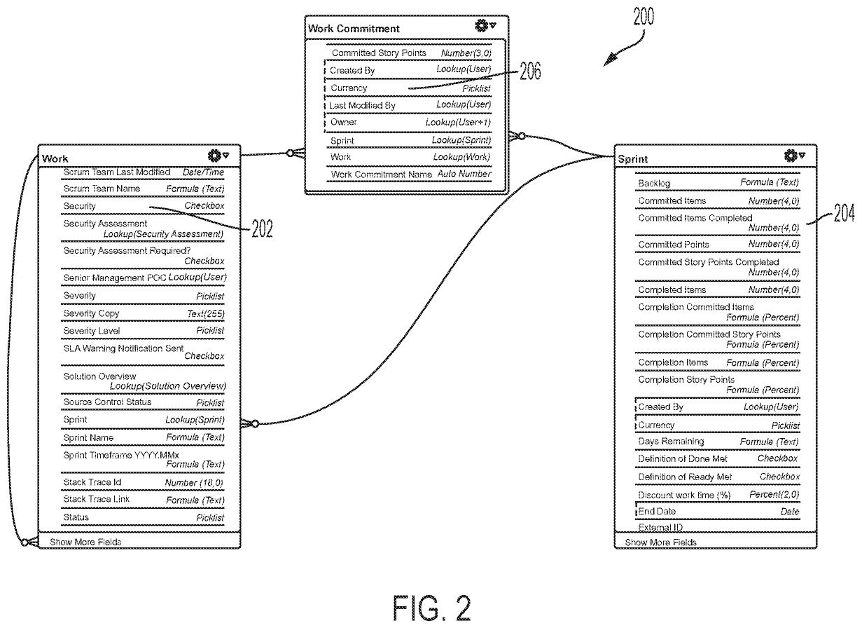

Turning now to FIG. 2, mobile device displays 200 are shown for a sprint task work commitment manager. In this embodiment, the interface is used on a mobile electronic device such as a smart phone or tablet. However, other embodiments could be used with a desktop computer. The displays include a work manager display 202 containing scrum details. The work task commitment manager interface 206 allows team members to lock in sprint commitments after the planning is completed. Individual team members are allowed to review their sprint commitments and make sure the team is met their performance benchmarks 204. Details of the commitments for story pointing may be contained in other applications outside of the commitment manager in other embodiments.

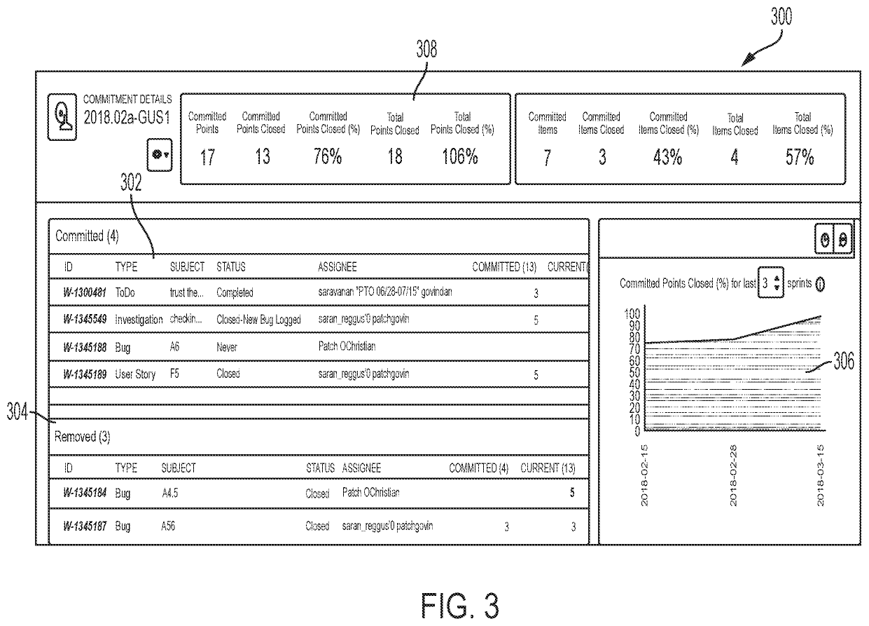

Turning now to FIG. 3, a dashboard display 300 is shown for monitoring commitment status and statistics for the sprint session of the work task commitment manager in accordance with one embodiment. This feature of the commitment manager allows the user to view their key commitment metrics (i.e., statistical data) 308 such as percentage completion rate of the commitments. Other features allow the display of simply the number of items committed 302, removed 304 and completed while other embodiments adjust the represented workload based on the size (i.e., time to complete) of the individual commitment. Additionally, the commitment metrics made to be displayed in a graphical format 306. The dashboard display 300 may be used by the scrum manager to view individual performance metrics of an individual team member or the performance metrics of the sprint as a whole. Likewise, the individual team member may have access to their individual performance metrics or the performance metrics of the sprint as a whole. Other embodiments may include a narrative to provide details of each work task commitment as part of the performance metrics. If the work task remains uncompleted, the narrative may include the reasons and explanations for incompletion.

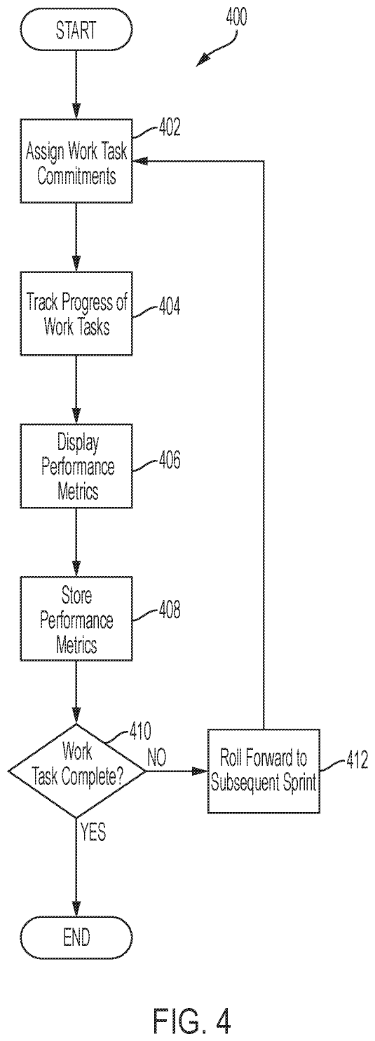

Turning now to FIG. 4, a flow chart 400 is shown of a method for task commitment confirmation for a sprint session in accordance with one embodiment. First, a plurality of work task commitments are assigned to individual development team members 402. The progress in completion of each task commitment is tracked 404 and the performance metrics (i.e., statistical data) are displayed 406. The performance metrics are stored for later retrieval and analysis 408. The performance metrics may include a narrative description of the work task commitment including reasons for an incomplete work task. If the work task is incomplete 410, the work task along with its performance metrics and narrative are rolled forward to a subsequent sprint 412.

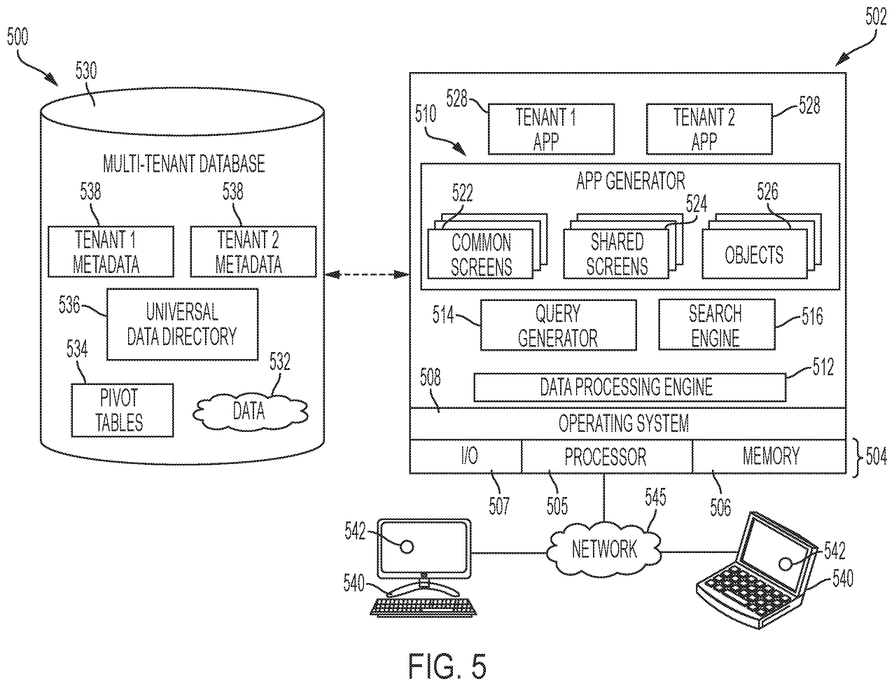

Turning now to FIG. 5, an exemplary multi-tenant system 500 includes a server 502 that dynamically creates and supports virtual applications 528 based upon data 532 from a database 530 that may be shared between multiple tenants, referred to herein as a multi-tenant database. Data and services generated by the virtual applications 528 are provided via a network 545 to any number of client devices 540, as desired. Each virtual application 528 is suitably generated at run-time (or on-demand) using a common application platform 510 that securely provides access to the data 532 in the database 530 for each of the various tenants subscribing to the multi-tenant system 500. In accordance with one non-limiting example, the multi-tenant system 500 is implemented in the form of an on-demand multi-tenant customer relationship management (CRM) system that can support any number of authenticated users of multiple tenants.

As used herein, a “tenant” or an “organization” should be understood as referring to a group of one or more users that shares access to common subset of the data within the multi-tenant database 530. In this regard, each tenant includes one or more users associated with, assigned to, or otherwise belonging to that respective tenant. Stated another way, each respective user within the multi-tenant system 500 is associated with, assigned to, or otherwise belongs to a particular one of the plurality of tenants supported by the multi-tenant system 500. Tenants may represent companies, corporate departments, business or legal organizations, and/or any other entities that maintain data for particular sets of users (such as their respective customers) within the multi-tenant system 500. Although multiple tenants may share access to the server 502 and the database 530, the particular data and services provided from the server 502 to each tenant can be securely isolated from those provided to other tenants. The multi-tenant architecture therefore allows different sets of users to share functionality and hardware resources without necessarily sharing any of the data 532 belonging to or otherwise associated with other tenants.

The multi-tenant database 530 may be a repository or other data storage system capable of storing and managing the data 532 associated with any number of tenants. The database 530 may be implemented using conventional database server hardware. In various embodiments, the database 530 shares processing hardware 504 with the server 502. In other embodiments, the database 530 is implemented using separate physical and/or virtual database server hardware that communicates with the server 502 to perform the various functions described herein. In an exemplary embodiment, the database 530 includes a database management system or other equivalent software capable of determining an optimal query plan for retrieving and providing a particular subset of the data 532 to an instance of virtual application 528 in response to a query initiated or otherwise provided by a virtual application 528, as described in greater detail below. The multi-tenant database 530 may alternatively be referred to herein as an on-demand database, in that the multi-tenant database 530 provides (or is available to provide) data at run-time to on-demand virtual applications 528 generated by the application platform 510, as described in greater detail below.

In practice, the data 532 may be organized and formatted in any manner to support the application platform 510. In various embodiments, the data 532 is suitably organized into a relatively small number of large data tables to maintain a semi-amorphous “heap”-type format. The data 532 can then be organized as needed for a particular virtual application 528. In various embodiments, conventional data relationships are established using any number of pivot tables 534 that establish indexing, uniqueness, relationships between entities, and/or other aspects of conventional database organization as desired. Further data manipulation and report formatting is generally performed at run-time using a variety of metadata constructs. Metadata within a universal data directory (UDD) 536, for example, can be used to describe any number of forms, reports, workflows, user access privileges, business logic and other constructs that are common to multiple tenants. Tenant-specific formatting, functions and other constructs may be maintained as tenant-specific metadata 538 for each tenant, as desired. Rather than forcing the data 532 into an inflexible global structure that is common to all tenants and applications, the database 530 is organized to be relatively amorphous, with the pivot tables 534 and the metadata 538 providing additional structure on an as-needed basis. To that end, the application platform 510 suitably uses the pivot tables 534 and/or the metadata 538 to generate “virtual” components of the virtual applications 528 to logically obtain, process, and present the relatively amorphous data 532 from the database 530.

The server 502 may be implemented using one or more actual and/or virtual computing systems that collectively provide the dynamic application platform 510 for generating the virtual applications 528. For example, the server 502 may be implemented using a cluster of actual and/or virtual servers operating in conjunction with each other, typically in association with conventional network communications, cluster management, load balancing and other features as appropriate. The server 502 operates with any sort of conventional processing hardware 504, such as a processor 505, memory 506, input/output features 507 and the like. The input/output features 507 generally represent the interface(s) to networks (e.g., to the network 545, or any other local area, wide area or other network), mass storage, display devices, data entry devices and/or the like. The processor 505 may be implemented using any suitable processing system, such as one or more processors, controllers, microprocessors, microcontrollers, processing cores and/or other computing resources spread across any number of distributed or integrated systems, including any number of “cloud-based” or other virtual systems. The memory 506 represents any non-transitory short or long term storage or other computer-readable media capable of storing programming instructions for execution on the processor 505, including any sort of random access memory (RAM), read only memory (ROM), flash memory, magnetic or optical mass storage, and/or the like. The computer-executable programming instructions, when read and executed by the server 502 and/or processor 505, cause the server 502 and/or processor 505 to create, generate, or otherwise facilitate the application platform 510 and/or virtual applications 528 and perform one or more additional tasks, operations, functions, and/or processes described herein. It should be noted that the memory 506 represents one suitable implementation of such computer-readable media, and alternatively or additionally, the server 502 could receive and cooperate with external computer-readable media that is realized as a portable or mobile component or platform, e.g., a portable hard drive, a USB flash drive, an optical disc, or the like.

The application platform 510 is any sort of software application or other data processing engine that generates the virtual applications 528 that provide data and/or services to the client devices 540. In a typical embodiment, the application platform 510 gains access to processing resources, communications interfaces and other features of the processing hardware 504 using any sort of conventional or proprietary operating system 508. The virtual applications 528 are typically generated at run-time in response to input received from the client devices 540. For the illustrated embodiment, the application platform 510 includes a bulk data processing engine 512, a query generator 514, a search engine 516 that provides text indexing and other search functionality, and a runtime application generator 520. Each of these features may be implemented as a separate process or other module, and many equivalent embodiments could include different and/or additional features, components or other modules as desired.

The runtime application generator 520 dynamically builds and executes the virtual applications 528 in response to specific requests received from the client devices 540. The virtual applications 528 are typically constructed in accordance with the tenant-specific metadata 538, which describes the particular tables, reports, interfaces and/or other features of the particular application 528. In various embodiments, each virtual application 528 generates dynamic web content that can be served to a browser or other client program 542 associated with its client device 540, as appropriate.

The runtime application generator 520 suitably interacts with the query generator 514 to efficiently obtain multi-tenant data 532 from the database 530 as needed in response to input queries initiated or otherwise provided by users of the client devices 540. In a typical embodiment, the query generator 514 considers the identity of the user requesting a particular function (along with the user's associated tenant), and then builds and executes queries to the database 530 using system-wide metadata 536, tenant specific metadata 538, pivot tables 534, and/or any other available resources. The query generator 514 in this example therefore maintains security of the common database 530 by ensuring that queries are consistent with access privileges granted to the user and/or tenant that initiated the request.

With continued reference to FIG. 5, the data processing engine 512 performs bulk processing operations on the data 532 such as uploads or downloads, updates, online transaction processing, and/or the like. In many embodiments, less urgent bulk processing of the data 532 can be scheduled to occur as processing resources become available, thereby giving priority to more urgent data processing by the query generator 514, the search engine 516, the virtual applications 528, etc.

In exemplary embodiments, the application platform 510 is utilized to create and/or generate data-driven virtual applications 528 for the tenants that they support. Such virtual applications 528 may make use of interface features such as custom (or tenant-specific) screens 524, standard (or universal) screens 522 or the like. Any number of custom and/or standard objects 526 may also be available for integration into tenant-developed virtual applications 528. As used herein, “custom” should be understood as meaning that a respective object or application is tenant-specific (e.g., only available to users associated with a particular tenant in the multi-tenant system) or user-specific (e.g., only available to a particular subset of users within the multi-tenant system), whereas “standard” or “universal” applications or objects are available across multiple tenants in the multi-tenant system. The data 532 associated with each virtual application 528 is provided to the database 530, as appropriate, and stored until it is requested or is otherwise needed, along with the metadata 538 that describes the particular features (e.g., reports, tables, functions, objects, fields, formulas, code, etc.) of that particular virtual application 528. For example, a virtual application 528 may include a number of objects 526 accessible to a tenant, wherein for each object 526 accessible to the tenant, information pertaining to its object type along with values for various fields associated with that respective object type are maintained as metadata 538 in the database 530. In this regard, the object type defines the structure (e.g., the formatting, functions and other constructs) of each respective object 526 and the various fields associated therewith.

Still referring to FIG. 5, the data and services provided by the server 502 can be retrieved using any sort of personal computer, mobile telephone, tablet or other network-enabled client device 540 on the network 545. In an exemplary embodiment, the client device 540 includes a display device, such as a monitor, screen, or another conventional electronic display capable of graphically presenting data and/or information retrieved from the multi-tenant database 530, as described in greater detail below. Typically, the user operates a conventional browser application or other client program 542 executed by the client device 540 to contact the server 502 via the network 545 using a networking protocol, such as the hypertext transport protocol (HTTP) or the like. The user typically authenticates his or her identity to the server 502 to obtain a session identifier (“SessionID”) that identifies the user in subsequent communications with the server 502. When the identified user requests access to a virtual application 528, the runtime application generator 520 suitably creates the application at run time based upon the metadata 538, as appropriate. As noted above, the virtual application 528 may contain Java, ActiveX, or other content that can be presented using conventional client software running on the client device 540; other embodiments may simply provide dynamic web or other content that can be presented and viewed by the user, as desired. As described in greater detail below, the query generator 514 suitably obtains the requested subsets of data 532 from the database 530 as needed to populate the tables, reports or other features of the particular virtual application 528.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

As used herein, a “node/port” means any internal or external reference point, connection point, junction, signal line, conductive element, or the like, at which a given signal, logic level, voltage, data pattern, current, or quantity is present. Furthermore, two or more nodes may be realized by one physical element (and two or more signals can be multiplexed, modulated, or otherwise distinguished even though received or output at a common node). As used herein, a “port” means a node that is externally accessible via, for example, a physical connector, an input or output pin, a test probe, a bonding pad, or the like.

In addition, certain terminology may also be used in the following description for the purpose of reference only, and thus are not intended to be limiting. For example, terms such as “upper”, “lower”, “above”, and “below” refer to directions in the drawings to which reference is made. Terms such as “front”, “back”, “rear”, “side”, “outboard”, and “inboard” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import.

For the sake of brevity, conventional techniques related to signal processing, data transmission, signaling, network control, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

The various tasks performed in connection with the method may be performed by software, hardware, firmware, or any combination thereof. For illustrative purposes, the following description of the method may refer to elements mentioned above. In practice, portions of the method may be performed by different elements of the described system, e.g., component A, component B, or component C. It should be appreciated that the method may include any number of additional or alternative tasks, the tasks need not be performed in the illustrated order, and the method may be incorporated into a more comprehensive procedure or process having additional functionality not described in detail herein. Moreover, one or more of the tasks could be omitted from an embodiment of the method as long as the intended overall functionality remains intact.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method of managing work task commitments for a software development sprint, comprising:
assigning a plurality of work task commitments to individual development team members;
tracking performance metrics and progress in the completion of the plurality of work task commitments;
displaying performance metrics of the work task commitments;
storing performance metrics for each work task commitment; and
rolling forward any uncompleted work task commitment to a subsequent sprint along with the performance metrics of the uncompleted work task commitment.

2. The method of claim 1, where the tracking performance metrics and progress is done over a predetermined period of time.

3. The method of claim 2, where the tracking performance metrics and progress is done daily.

4. The method of claim 1, where the tracking performance metrics and progress may be interrupted by development team leader.

5. The method of claim 1, further comprising:
calculating statistical data based on tracking performance metrics and progress in the completion of the plurality of work task commitments.

6. The method of claim 5, where the statistical data is calculated for all of the plurality of work task commitments.

7. The method of claim 5, where the statistical data is calculated for each individual development team member.

8. The method of claim 5, where the statistical data may be displayed in a graphical format.

9. The method of claim 5, where the statistical data comprises the completion percentage of the plurality of work task commitments.

10. The method of claim 5, where the statistical data comprises the size of each individual work task commitment.

11. The method of claim 1, where the performance metrics are displayed for all of the plurality of work task commitments.

12. The method of claim 1, where the performance metrics are displayed each individual development team member.

13. The method of claim 12, where the individual team development member may access the displayed performance metrics for their assigned work task commitments.

14. The method of claim 1, where the performance metrics include a narrative of the details of each work task commitment.

15. The method of claim 14, where the narrative comprises reasons for an uncompleted work task commitment.

16. A computer readable storage media comprising:
a processor; and
a memory of readable storage media coupled to the processor, wherein the memory includes computer program instructions capable of:
assigning a plurality of work task commitments to individual development team members;
tracking performance metrics and progress in the completion of the plurality of work task commitments;
displaying performance metrics of the work task commitments;
storing performance metrics for each work task commitment; and
rolling forward any uncompleted work task commitment to a subsequent sprint along with the performance metrics of the uncompleted work task commitment.

17. The storage media of claim 16, where the computer readable storage media is located on a mobile communications device.

18. The storage media of claim 17, where the mobile communications device comprises a smart phone.

19. The storage media of claim 17, where the mobile communications device comprises a tablet device.
